(19) United States
(12) Patent Application Publication
(10) Pub. No.: US 2012/0084828 A1
(43) Pub. Date: Apr. 5, 2012

(54) System and Method for Linking Web Browsing with Television Viewing

(76) Inventors: Simon Michael Rowe, Finchampstead (GB); Raimundo Mirisola, London (GB)

(21) Appl. No.: 13/171,263

(22) Filed: Jun. 28, 2011

Related U.S. Application Data
(60) Provisional application No. 61/389,692, filed on Oct. 4, 2010.
(60) Provisional application No. 61/390,154, filed on Oct. 5, 2010.

(51) Int. Cl. H04N 7/173

(52) U.S. Cl. 725/110

(57) ABSTRACT

A server receives an IP address associated with an account of a TV subscriber using a TV service. The IP address is associated with a set top box employed by the TV subscriber to display TV content provided by the TV service. The IP address is also associated with computers of a household corresponding to the TV subscriber. The computers use web browsers to view Internet content. The server receives information on TV viewing, including the IP address. The server also receives information on web browsing activity in the household associated with the IP address. The information includes the IP address. The server maintains a TV log of the TV viewing and maintains an Internet log of the web browsing activity in the household associated with the IP address. The server associates entries in the TV log with entries in the Internet log(using IP address), and stores the associations.

### RELATED APPLICATIONS

This application claims priority under 35 U.S.C. 119(e) to U.S. Provisional Patent Application Ser. No. 61/389,692 filed Oct. 4, 2010, entitled “System and Method for Linking Web Browsing with Television Viewing,” and to U.S. Provisional Patent Application Ser. No. 61/390,154 filed Oct. 5, 2010, entitled “System and Method for Providing Real Time Television Viewing Information and Popularity to Viewers,” both of which are hereby incorporated by reference in their entirety.

### TECHNICAL FIELD

The disclosed embodiments relate generally to television viewing activity and web browsing activity.

### BACKGROUND

Television viewers have been watching television programs for more than fifty years. In the beginning, a small number of programs were broadcast over the airwaves, and users selected among those channels. Over time, more television viewers have come to receive their television programs from a satellite network or cable network. In addition to standard programming, satellite and cable networks offer premium channels, pay-per-view programs, and a host of interactive programs. Interactive programs are made possible by a set top box that receives the broadcast signal and also has access to the Internet. Set top boxes may also transmit viewer information back to the television provider, giving the provider more information about what programs people are watching.

Television viewers also access the Internet using computers or other devices. Using the Internet, a user can search for information, shop for clothes, books, electronic equipment, medical supplies, etc., watch videos on YouTube, connect with friends and family on social networking sites, play online games, and engage in lots of other activities.

Previously, television viewing activity and web browsing activity were disconnected. Web browsing activity may be stored in logs on servers, and television viewing activity may be tracked by television providers, but there was no process to match or correlate these activities.

### SUMMARY OF THE INVENTION

Most Internet-enabled devices in a household (e.g., computers, MP3 players, game consoles, etc.) share the same IP address (e.g., the IP address of a home router). The IP address is associated with a TV account and viewing information for a set top box. Knowing this IP address enables the correlation of Web search logs, media content access logs, etc. (reflecting prior Internet activity by users for the same IP address) with log data of TV viewing information associated with the same account.

By correlating television viewing activity with web activity, it is possible to make suggestions to viewers as to other content of interest, present targeted ads, etc. reflecting preferences/behavior revealed by the combined log information. This correlation also enables providing valuable information to advertisers as to viewing and Internet behaviors of different viewer segments.

In disclosed embodiments, the IP address used by a set top box to transmit data back to a television provider (with the user's account id) is linked to web logs (e.g., from ad networks), and this is almost always the same household. This enables linking a TV to a computer/household, without burdening a user at the household.

In some embodiments, linking of web browsing with television viewing is implemented on a server with one or more processors and memory. The memory stores programs that are executed by the processors. The server receives an IP address associated with an account of a TV subscriber. In some embodiments, the IP address is received from a TV service provider, such as a cable television network or a satellite television network. The IP address is associated with a set top box employed by the TV subscriber to display TV content provided by the TV service. The IP address is also associated with one or more computers in the household corresponding to the TV subscriber. The one or more computers are configured to run web browsers. The server receives information on TV viewing of the TV subscriber, including the IP address of the household. The server also receives information on web browsing activity of the computers in the household associated with the IP address. The information on web browsing activity includes the IP address. The server maintains a TV log of the TV viewing of the TV subscriber, and maintains an Internet log of the web browsing activity of the computers in the household associated with the IP address. The server associates entries in the TV log with entries in the Internet log, and stores the associations. The server associates the entries, at least in part, using the IP address.

In some embodiments, a computer system for linking TV viewing with Internet activity has memory, one or more processors, and one or more programs stored in the memory. The programs are configured for execution by the one or more processors. The one or more programs include instructions for receiving an IP address associated with an account of a TV subscriber. In some embodiments, the IP address is received from a TV service provider, such as a cable television network or a satellite television network. The IP address is associated with a set top box employed by the TV subscriber to display TV content provided by the TV service. The IP address is also associated with one or more computers in the household corresponding to the TV subscriber. The one or more computers are configured to run web browsers. The programs include instructions for receiving information on TV viewing of the TV subscriber, including the IP address. The programs also include instructions for receiving information on web browsing activity of the computers in the household associated with the IP address. The information on web browsing activity includes the IP address. The programs include instructions for maintaining a TV log of the TV viewing of the TV subscriber, and instructions for maintaining an Internet log of the web browsing activity of the computers in the household associated with the IP address. The programs include instructions for associating entries in the TV log with entries in the Internet log using the IP address, and instructions for storing the associations.

In some embodiments, a non-transitory computer readable storage medium stores one or more programs to be executed by a computer system. The one or more programs include instructions for receiving an IP address associated with an account of a TV subscriber. In some embodiments, the IP address is received from a TV service provider, such as a cable television network or a satellite television network. The IP address is associated with a set top box employed by the TV subscriber to display TV content provided by the TV service. The IP address is also associated with one or more computers in the household corresponding to the TV subscriber. The one or more computers are configured to run web browsers. The programs include instructions for receiving information on TV viewing of the TV subscriber, including the IP address of the household. The programs also include instructions for receiving information on web browsing activity of the computers in the household associated with the IP address. The information on web browsing activity includes the IP address of the household. The programs include instructions for maintaining a TV log of the TV viewing of the TV subscriber, and instructions for maintaining an Internet log of the web browsing activity of the computers in the household associated with the IP address. The programs include instructions for associating entries in the TV log with entries in the Internet log, and instructions for storing the associations. The instructions for associating the TV log entries with the Internet log entries access the IP addresses corresponding to the entries.

### BRIEF DESCRIPTION OF THE DRAWINGS

FIG. 1 is a block diagram of a system that correlates web browsing activity with television viewing activity in accordance with some embodiments.

FIG. 2 is a functional block diagram of a client household computer in accordance with some embodiments.

FIG. 3 is a functional block diagram of a log server in accordance with some embodiments.

FIG. 4 is a functional block diagram of a television set top box in accordance with some embodiments.

FIG. 5 is an exemplary screen shot viewed by a panelist who participates in a research panel in accordance with some embodiments.

FIGS. 6-7 are exemplary screen shots of programs used to manage a research panel in accordance with some embodiments.

FIG. 8 illustrates a process used to generate and correlate survey information from panelists according to some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

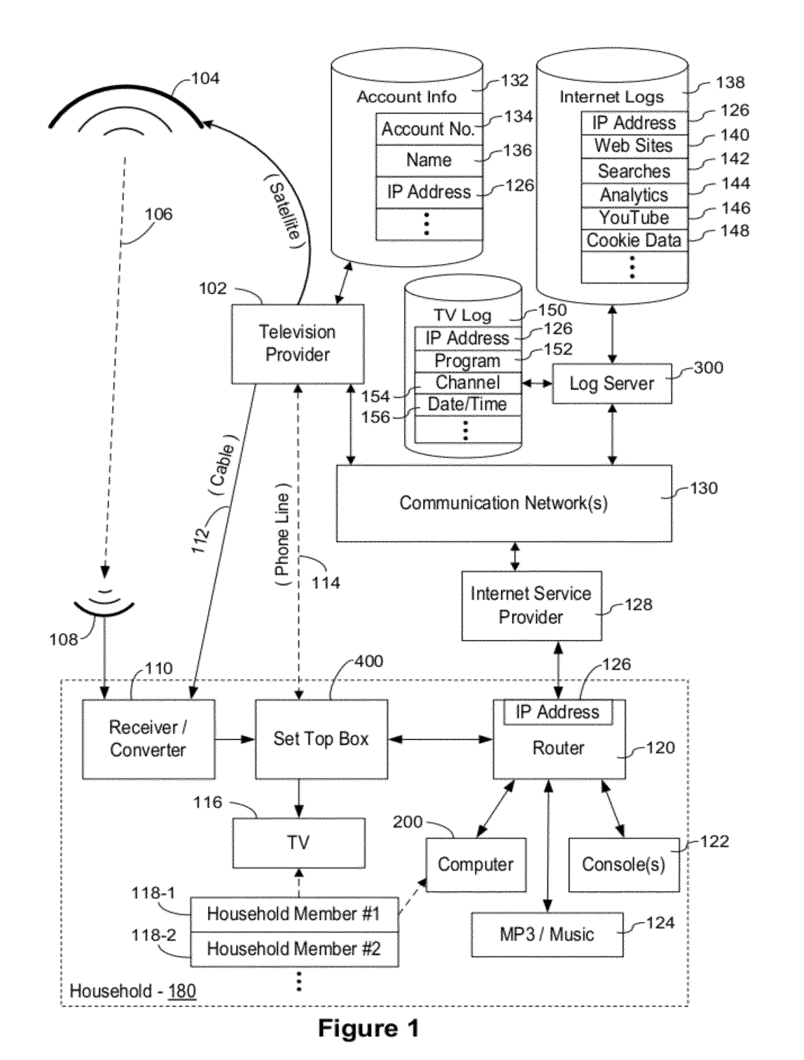

Embodiments illustrated in FIG. 1 can be used to correlate web browsing activity with television viewing activity. In some embodiments, the television provider 102 maintains an account in an Account Information database 132 for each household 180. The account information generally includes an account number 134 and a name 136. In some embodiments, the account information also includes a billing address and/or a physical address, which may be a residence address. In order to enable more features, the provider 102 may also track the IP address 126 of the household 180. In some cases, the household 180 has a fixed IP address 126, in which case the single fixed IP address 126 is associated with the account. In other cases, the subscriber has a dynamic IP address, which can change on a regular basis (e.g., every time the user “dials up” the Internet service provider 128 (ISP)). In some embodiments, the television provider 102 tracks the changes to the household's IP Address 126, at least when a household member 118 at the household 180 is viewing television programs.

In some embodiments, the television viewing activity at the household 180 is tracked in a TV log database 150. In some embodiments, the viewing activity includes every program viewed by the household. In other embodiments, the viewing activity tracked includes only programs that are viewed at least a threshold amount of time (e.g., 1 minute or 5 minutes). In some embodiments, the viewing activity tracked includes only premium content. The TV viewing activity that is tracked generally includes the program 152, the channel 154, and the date/time 156 of the viewing. When the IP address 126 is available, it is generally included in the TV log data. In some embodiments, the tracking of TV viewing is performed by a log server 300.

The television provider 102 transmits the television programs to the household 180 over a cable 112, by transmission from a satellite 104, or by streaming over the Internet (described below). In the case of satellite transmissions 106, the household 180 has an antenna 108 to receive the signal. At the household 180 there is a receiver or converter 110 to process or decode the incoming signals. The television signals are transmitted to a set top box 400, which allows household members 118 to control what is being displayed on the television 116. In some embodiments, the receiver/converter 110 is combined with the set top box 400. In general, a household member, such as member 118-1 or 118-2 controls the set top box 400 with a remote control device. In some embodiments, there is additional communication between the television provider 102 and the set top box 400 over a telephone line 114. For example, the set top box may provide information about what television programs are being viewed, or may receive further information for interactive television programs.

In some embodiments, the viewing activity is identified by the receiver/converter 110, and transmitted to the television provider 102 through the set top box 400, which is connected to the communication network 130 (e.g., the Internet) through a home router 120. In other embodiments, the set top box 400 is able to ascertain the program viewed by evaluating the signal received from the receiver/converter 110. In these embodiments, the set top box transmits the viewing information (e.g., program, channel, date/time, etc.) to the television provider 102, again via the household router 120. Because the viewing information is transmitted through the household router 120, the IP address 126 of the router can be transmitted to the television provider 102 along with the viewing information. In some embodiments the IP address 126 and/or viewing information is transmitted to the television provider 102 on a periodic basis (e.g., once a day). When the viewing information is transmitted periodically, the data is stored in the set top box 400 between transmissions. As noted above, in some alternative embodiments, the set top box 400 transmits data to the television provider 102 over a phone line 114. In some of these embodiments, the set top box 400 is able to retrieve the IP address 126 from the router and transmit it with the viewing data.

In some embodiments, the household connection to the Internet uses a distinct modem (e.g., DSL modem or cable modem) and an internal router (this configuration is not shown in FIG. 1). In this case, the IP address 126 of the household 180 is the IP address 126 of the modem, which uniquely identifies the household 180 to the “outside world.” (In this case the IP address of the router 120 would be relevant only to the internal household network.) In the embodiment shown in FIG. 1, the router and modem are combined in the single box labeled “Router.”

The actual television program signals are generally transmitted by satellite 104 or over a cable 112. In some embodiments, the television programs are streamed over the communications network 130, such as the Internet. In these embodiments, the process of selecting a television program may be performed by a computer 200, the set top box 400, or a receiver/converter 110 that is connected directly to the household router 120 (not shown in FIG. 1).

The home router 120 is the gateway to the Internet from the household 180. The router 120 has one external IP address 126, and that is the IP address that is relevant to various embodiments described herein. Internally, the router 120 is connected to the set top box 400, and in some cases to any number of computers 200, digital audio players 124, or game consoles 122, such as XBOX, PLAYSTATION or WII. The router 120 is connected to the communication network 130 through an Internet service provider 128. The Internet service provider 128 assigns the IP address 126 to the home router 120. As noted before, the IP Address 126 can be static (fixed) or dynamic (changing). In general, dynamic IP addresses change only when the connection between the router and the Internet service provider 128 is broken (e.g., when using a dial-up modem).

The computers 200 in the household 180 can access the Internet to perform a myriad of activities, such as searching for data (e.g., using a search engine), shopping, viewing videos online (e.g., on YouTube), playing online games, participating in online social networks, or engaging in many other activities. Some of these web browsing activities are logged on one or more log servers 300 in an Internet log database 138. For example, the log 138 may track web site visits 140 or search queries 144. Many other Internet activities are logged, such as online shopping conversions and viewing advertisements. In addition, many web sites track browsing 144 on their sites using Google Analytics. Web browsing activities are generally tracked by the IP Address 126 of the household 180 because it is readily available and it is a unique identifier (at least at a specific point in time). In some embodiments, there is specific tracking for visits to YouTube 146 or other particular sites of interest. In some embodiments, the Internet log 138 includes cookies 148 that are downloaded during the web activity.

One of skill in the art would recognize that the data identified in Internet log database 138 and TV log database 150 could be in a single database, or distributed to a different number of databases depending on the implementation.

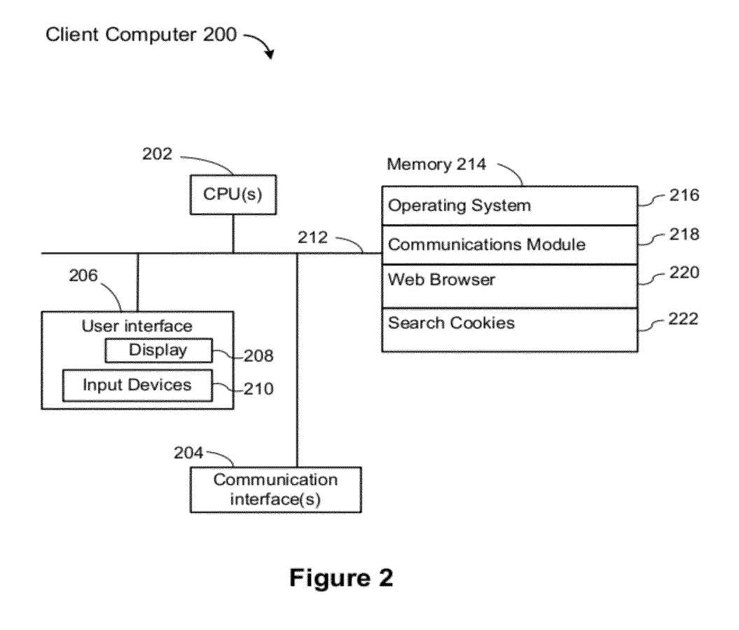

FIG. 2 illustrates a typical client computer 200 at a household 180. A client computer 200 generally includes one or more processing units (CPUs) 202, one or more network or other communications interfaces 204, memory 214, and one or more communication buses 212 for interconnecting these components. The communication buses 212 may include circuitry (sometimes called a chipset) that interconnects and controls communications between system components. A client computer 200 includes a user interface 206, for instance a display 208 and one or more input devices 210, such as a keyboard and a mouse. Memory 214 may include high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 214 may include mass storage that is remotely located from the central processing unit(s) 202. Memory 214, or alternately the non-volatile memory device(s) within memory 214, comprises a computer readable storage medium. In some embodiments, memory 214 or the computer readable storage medium of memory 214 stores the following programs, modules and data structures, or a subset thereof:
an operating system 216 (e.g., WINDOWS or MAC OS X) that generally includes procedures for handling various basic system services and for performing hardware dependent tasks;
a network communications module 218 that is used for connecting the client computer 200 to servers or other computing devices via one or more communication networks, such as the Internet, other wide area networks, local area networks, metropolitan area networks, and the like;
a web browser 220, which allows a user of the client computer 200 to access web sites and other resources over the communication network; and
one or more cookies 222, which provide persistent data for web sites visited by a household member 118 at the client computer 200.

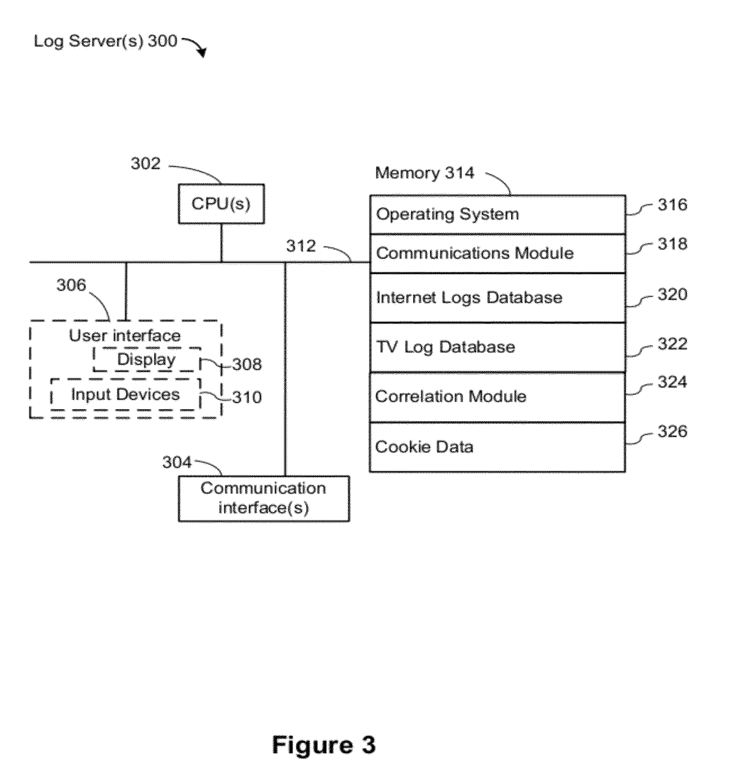

Referring to FIG. 3, the log server 300 generally includes one or more processing units (CPUs) 302, one or more network or other communications interfaces 304, memory 314, and one or more communication buses 312 for interconnecting these components. The communication buses 312 may include circuitry (sometimes called a chipset) that interconnects and controls communications between system components. The log processor 300 may optionally include a user interface 306, for instance a display 308 and a keyboard 310. Memory 314 may include high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 314 may include mass storage that is remotely located from the central processing unit(s) 302. Memory 314, or alternately the non-volatile memory device(s) within memory 314, comprises a computer readable storage medium. In some embodiments, memory 314 or the computer readable storage medium of memory 314 stores the following programs, modules and data structures, or a subset thereof:
an operating system 316 (e.g., Linux or Unix) that generally includes procedures for handling various basic system services and for performing hardware dependent tasks;
a network communications module 318 that is used for connecting the log server 300 to servers or other computing devices via one or more communication networks, such as the Internet, other wide area networks, local area networks, metropolitan area networks, and the like;
one or more Internet Logs Databases 320, which store information about online web browsing activity. The logs include the IP address of the household. The browsing activity can include web searches, information collected by analytics systems, such as Google Analytics, viewing YouTube videos, cookie data, online shopping, etc.;
a TV log database 322, which stores information about Household television viewing activity. The log generally includes program names (if known), channel, and date/time;
a Correlation module 324 which correlates television viewing activity with web browsing activity.
a Cookie data database or file store 326, which tracks cookie data from web sites visited by a user.

The correlation module 324 may also convert the information from the log entries in databases 320 and 322 into aggregated data. In some embodiments, the log data processing module 324 processes the IP or web address to determine geographic information, such as country, state and city.

Although FIG. 3 shows a log server, FIG. 3 is intended more as functional descriptions of the various features which may be present in a set of servers than as a structural schematic of the embodiments described herein. In practice, and as recognized by those of ordinary skill in the art, items shown separately could be combined and some items could be separated. For example, some items shown separately in FIG. 3 could be implemented on single server and single items could be implemented by one or more servers. The actual number of servers used to implement a log server, and how features are allocated among them will vary from one implementation to another, and may depend in part on the amount of data traffic that the system must handle during peak usage periods as well as during average usage periods.

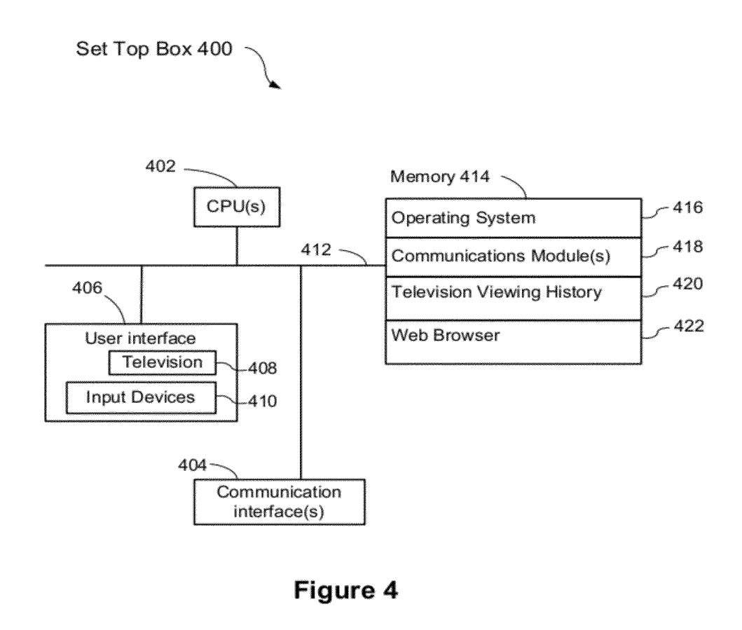

FIG. 4 illustrates an exemplary set top box in accordance with some embodiments. A set top box is similar to a computer, having one or more CPU's 402 and memory 414. The set top box includes multiple communications interfaces 404, enabling connection to a Receiver/Converter 110, connection to a television 116, and connection to a home network (usually a router 120). The User Interface 406 of the set top box is the television 408 and a remote control device 410. In some embodiments, the set top box also includes a keyboard as an input device.

A set top box includes one or more communication buses 412 for interconnecting these components. The communication buses 412 may include circuitry (sometimes called a chipset) that interconnects and controls communications between system components. Memory 414 may include high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 414 may include mass storage that is remotely located from the central processing unit(s) 402. Memory 414, or alternately the non-volatile memory device(s) within memory 414, comprises a computer readable storage medium. In some embodiments, memory 414 or the computer readable storage medium of memory 414 stores the following programs, modules and data structures, or a subset thereof:
an operating system 416 (e.g., Linux or Unix) that generally includes procedures for handling various basic system services and for performing hardware dependent tasks;
a network communications module 418 that is used for connecting the set top box 400 to a home network;
a database or file system to store television viewing history 420;
in some embodiments, the set top box includes a web browser 422, so that a user can utilize a television to access the Internet.

Each of the methods described herein may be performed by instructions that are stored in a computer readable storage medium and that are executed by one or more processors of one or more servers or clients. Each of the operations shown in FIGS. 1-4 may correspond to instructions stored in a computer memory or computer readable storage medium.

Associating TV Viewing with Web Activity for a Single Source Panel

A “single source panel” is an all-in-one ratings system that measures viewership across television and the Internet.

Both television viewing activity and web usage activity are useful indicators of future activities of an individual household as well as aggregate trends. Combining these two disparate types of data can provide even more valuable information. In order to do this, the data from television viewing has to be correlated to web usage activity for the same household, or even the same user.

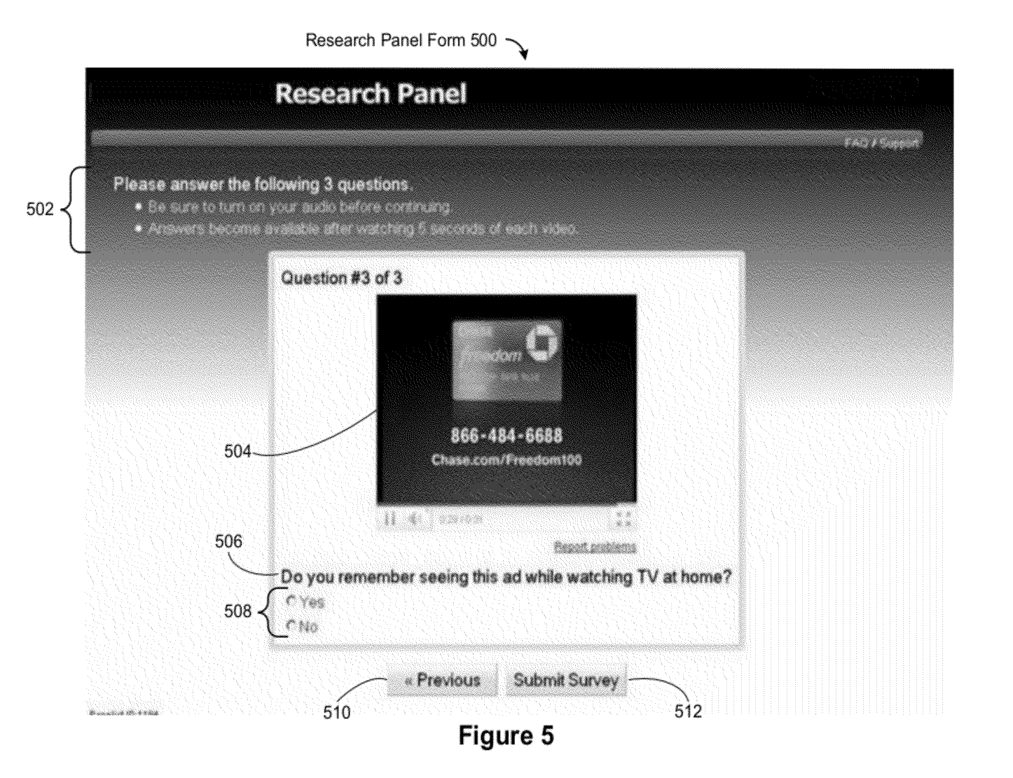

Previously, the only way to get correlated data is with the use of surveys. For example, a sample page of an exemplary survey is depicted in FIG. 5. In a typical survey tool 500, there are three ads 504 that were actually shown at the household, and another three ads that were not shown (used as a control group). A consumer completes the survey in 2-3 minutes, and indicates which ads were remembered. The tool 500 asks (502) questions of the panelist, and instructs (502) the panelist how to use the tool. The panelist answers (508) yes or no to each question 506. The panelist can return (510) to a previous ad, or submit (512) the survey after answering all of the questions.

As described above, some embodiments associate TV viewing data and web usage data on a per household/per user basis. This is made possible in some embodiments by recognizing that, at any given time, most or all Internet-enabled devices in a household will access the Internet through a common router and, as a result, share a common IP address. As already described, the IP address can be static or dynamic. In the case where the IP address is dynamic and changes over time (e.g., when the IP address is assigned dynamically by an ISP using DHCP) the IP address for the household can be logged at a web server (such as the Google TV set top box 400, the log server 300, or the TV provider 102). In this way, historical TV viewing data and web usage can still be associated with a particular household/user over the corresponding period of time.

In particular, when a set top box 400 used by a household 180 connects to the Internet through the same router 120 as other Internet-enabled electronic devices in the household, the set top box 400 shares the same IP address 126 as those devices. As a result, TV viewing data 150 reported by the set top box 400 (e.g., to the Google TV server, log server 300, and/or the TV provider 102) can be stored and associated with the same household 180 and IP address 126 as that associated with web activity data 138 reported by Internet-enabled electronic devices from the same household 180.

By associating TV viewing data 150 and web usage data 138 using a common key associated with a particular household 180 or user (e.g., a household IP address 126), it is possible to provide additional value and services to viewers, advertisers who place ads with a TV provider to insert into that providers TV content, and the TV provider.

For example, TV providers (such as cable providers or satellite providers) often wish to enroll viewers in panels to answer surveys related to TV or movie content, or the ads displayed therewith. FIG. 5 shows an exemplary screen from a survey tool 500 presented on a TV via a set top box to an enrolled panelist. This particular screen asks panelists if they remember seeing a particular ad while watching TV in the past week. This and similar survey tools can be presented to a household/user once a week, for example, and can survey the user on a number of ads chosen for that household/user based on logs of TV viewing data and web usage data retained by the log server shown in FIG. 1. For example, in some embodiments, a survey tool shown once per week to a user could test 6 targeted ads, including 3 ads known to be shown to the household/user in the prior week (using TV viewing data for the household) and 3 control ads (selected based on associated TV viewing and web usage data for the household, determined and stored by the log server as described above).

In addition, for such surveys to be useful to an advertiser, the selected panelists must be within the target population (e.g., in the right demographic segment and having an appropriate viewing history and/or set of interests) and they must be willing to complete the survey tools. Conventionally, identifying appropriate panelists has required the use of lengthy screening procedures, including written and/or online questionnaires, and incentives for panelists to complete the surveys. While these approaches may be effective for small panels, they are cumbersome if used for large panels (for example, to generate surveys for those large panels). Information from large panels is especially useful because it can be aggregated and used to spot trends among large groups of users. The information can also provide helpful information for targeting ads and content for large numbers of individual households.

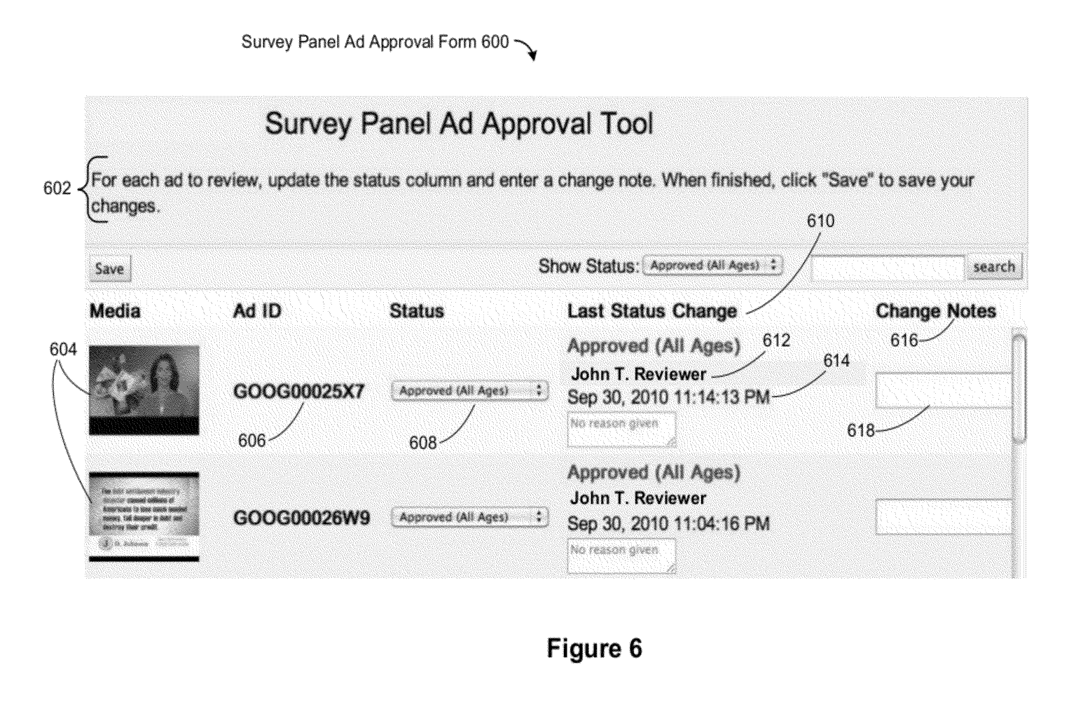

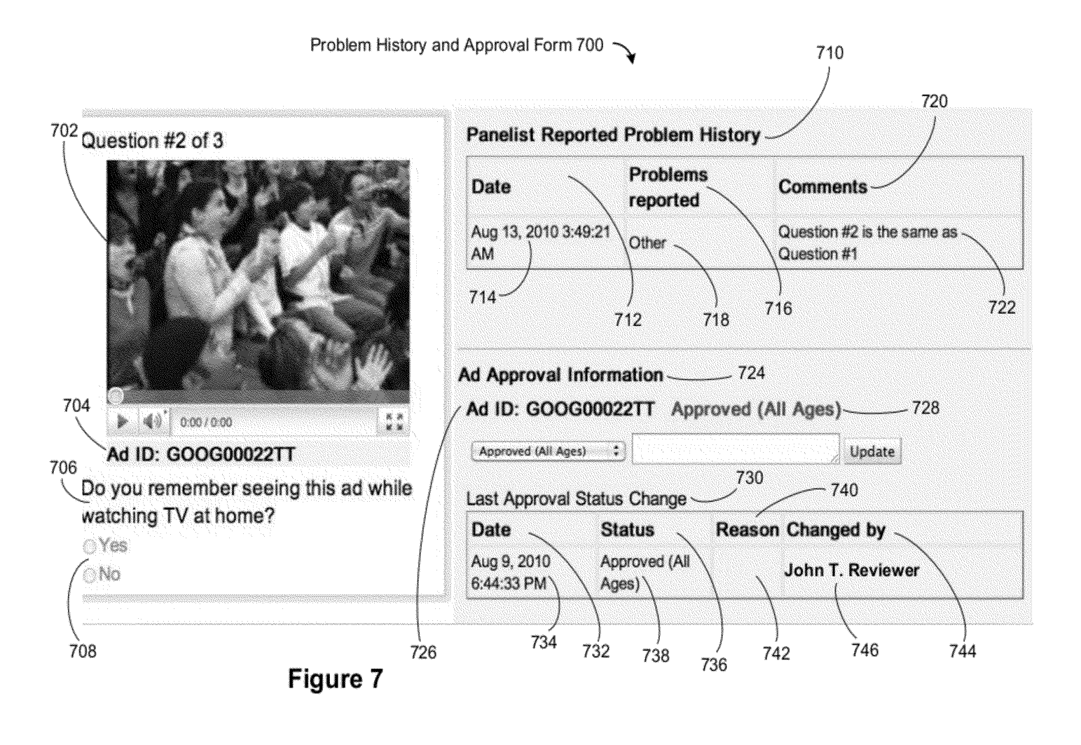

For example, a method implemented at a log server 300 or a computer system at a TV provider 102 can conduct searches on the associated TV viewing 150 and web usage data 138 for individual households to generate survey tools 500 for individual panelists and identify likely panelists. For example, likely panelists can be identified based on TV content viewed, records of click-through history for web ads, and logs of media content viewed. Once identified, the surveyor can interact with the panelists and prospective panelists through additional status and approval screens, such as the screens illustrated in FIGS. 6 and 7. Panelist feedback can also be associated with the IP address 126, and used to tailor subsequent survey tools. In some embodiments, this process can also be used to identify and place panelists, households, or set top boxes on a white list, indicating clearance and willingness to participate in surveys.

FIG. 6 illustrates a Survey Panel Ad Approval Tool 600, which is an interactive web form. The form 600 instructs (602) a panelist how to use the form. The form displays one or more media excerpts 604, which can be film clips, individual frames from film clips, or single images (e.g., from a web-based advertisement). Each media excerpt advertisement 604 has a corresponding Ad ID 606, and a corresponding status 608. In some embodiments, the status indicates the audience for which the panelist considers the ad to be approved (e.g., what ages, such as “all,” “18+,” or “21+”). In some embodiments, form 600 includes an indicator 610 of the last (most recent) status change. In some embodiments, the information on the last status change includes the name 612 of the panelist who made the change, and the date/time 614 when the change was made. Some embodiments also include change notes 616, which provides free-form space 618 for the panelist to write additional notes.

FIG. 7 illustrates a Problem History and Ad Approval tool 700, which is used in some embodiments to track both approvals as well as problems identified by panelists. In the illustrated embodiment, the form 700 displays an advertisement 702, together with the corresponding Ad ID 704, which uniquely identifies the advertisement. In some embodiments, the advertisement 702 is displayed together with a question 706 asking the panelist whether the advertisement 702 had been seen. In these embodiments, there is space 708 to answer the question, which may be implemented as a pair of yes/no radio buttons. In some embodiments, the form includes a control (not shown) to move forward or backward in the set of questions.

The form 700 includes a problem history section 710, which enables panelists to report problems with the survey questions. In the illustrated embodiment, a panelist can specify the problem category 716 and additional comments 720. In some embodiments, there is also a date field 712 for each problem. In preferred embodiments, the form automatically fills in the date 714 during entry or when saved. The panelist specifies the problem category 718 (e.g., “other” in the illustrated embodiment) and comments 722.

The ad approval section 724 in form 700 is similar to FIG. 6. Because FIG. 7 illustrates a combination problem history/ad approval form 700, there is less space available for ad approval. In the illustrated embodiment, the approval information corresponds to the one ad 702 shown on the form 700. In this embodiment, the Ad ID 726 is repeated (duplicating Ad ID 704). Some embodiments omit this repetition. The ad approval section 724 also includes the approval status 728. The approval status 728 may indicate an age range for which the panelist believes the ad is appropriate. Similar to the embodiment of FIG. 6, the ad approval section 724 includes the last approval status change 730, which typically includes the date 732, the changed status 736, the reason 740 for the change, and the name 744 of the panelist making the change. The values for these fields (date 734, status 738, reason 742, and panelist 746) may be displayed below the field labels. In preferred embodiments, the date and panelist name are filled in automatically by the form. In some embodiments, the reason 740 is optional, and thus the reason field 742 may be blank as illustrated in form 700.

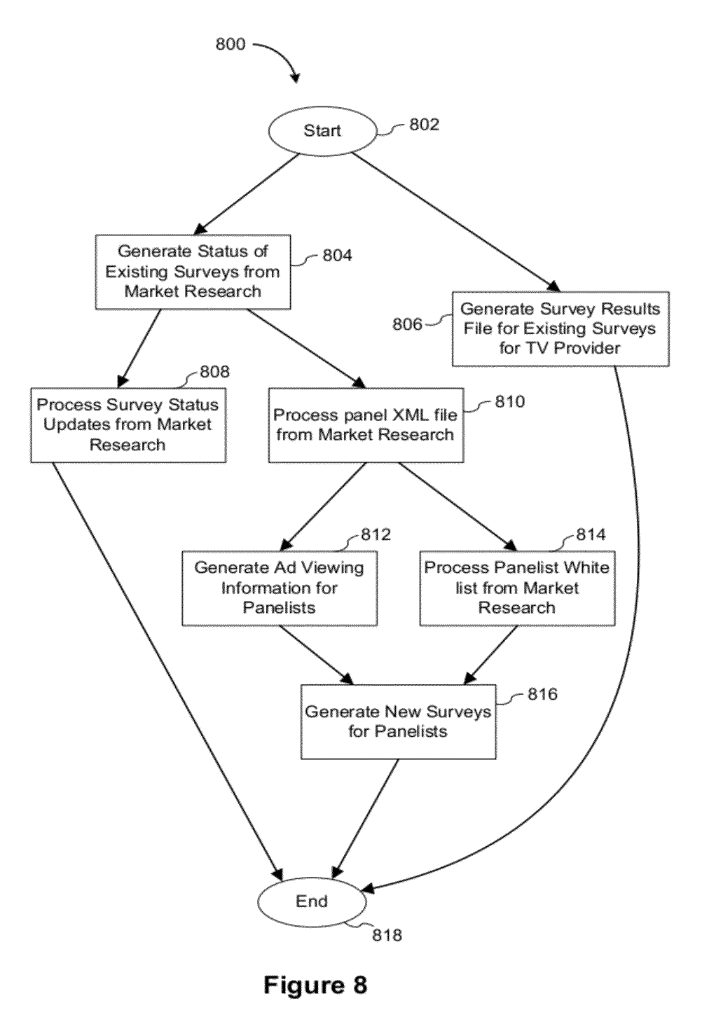

Using the log information maintained by the log server 300, some embodiments are configured to automatically generate new surveys and otherwise monitor the progress of surveys. For example, FIG. 8 shows an exemplary process flow for a process that automatically generates survey tools. This flow employs a log file, which is an XML file in this example. The log file represents TV viewing and web usage data for one or more households to generate ad viewing information for panelists and to identify panelists for a particular survey from white list information. Using this information, the flow then generates new surveys for the white listed panelists. In other words, using the associated TV and web data, along with panelist information, such as white list information, the flow automatically generates appropriate ads for surveying each enrolled household (including already viewed ads and control ads).

When the illustrated process flow 800 in FIG. 8 starts (802), two independent operations occur. In one branch of the process flow 800, the status of existing surveys from the market research system is generated (804). In some embodiments, the generation (804) includes creating an XML file of panelists and survey results. In addition, the process flow 800 generates (806) a survey results file for existing surveys. The survey results file may include partially completed surveys, or may be limited to surveys that are fully complete.

After the survey status is generated (804), some embodiments process (810) the created panel XML file. While processing (810) the panel XML file, the process flow 800 generates (812) ad viewing information for the panelists and processes (814) the panelist white list from the market research system. In some embodiments, the panelist white list identifies TV subscribers who meet the eligibility requirements (e.g., having appropriate hardware and software). Using the ad viewing information and the panelist white list, the process 800 generates (816) new surveys for panelists. In addition, the process flow 800 processes the survey status updates from the market research systems. The process flow 800 ends (818) when the survey status updates are processed (808), the new surveys for panelists are generated (816), and the survey results for existing surveys are generated (806).

Some disclosed embodiments provide an alternative simplified process that utilizes a set top box and Internet connectivity. An interactive application runs on the set top box that enables correlation of web browsing activity and television viewing activity. Because both types of activity are known, appropriate panelists can more easily be identified. In addition, when users agree to become panelists, much of the data can be tracked automatically, removing the burden of responding to many survey questions.

To qualify a household 180 as a panelist, the interactive application initially reviews the operating systems and browser(s) used at the household to determine if they are compatible with the application software. In order to attract a sufficient number of panelists, various incentives can be provided. For example, panelists may receive cash compensation, credit towards viewing Pay-Per-View movies, discounts on premium channels, sweepstakes entries, or other incentives.

Access to both television viewing activity and web browsing activity enables the creation of a “white list” of active set top boxes. The households with active set top boxes may be contacted for enrollment as panelists. Because eligibility for enrollment can be calculated automatically, a much greater number of panelists can be enrolled. Furthermore, because much of the data can be automatically collected after enrollment, there is greater accuracy, and fewer panelists discontinue as panelists because the burden of answering survey questions is greatly reduced.

An Exemplary Embodiment

One exemplary embodiment includes the following:
Use an interactive application on the TV to passively recruit panelists;
Each panelist explicitly opts in to joining the panel;
The interactive application enters some data into the set top box log, which is reported back to the television provider and/or web log provider;
The IP address currently assigned to the user household of the set top box is logged and associated to a unique panelist ID;
The set top box receiver ID (identifier of the Receiver/Converter 110) is used to match the account ID (identifier of the user's account with the television provider) to the panelist ID;
The account ID is used to match all other (not necessarily IP) reporting boxes or devices to the panelist ID;
The IP address logged is used as a key to find and extract Internet log data, particularly cookies which can potentially be used to map web visits and searches across all Internet devices in the household;
IP addresses are usually dynamic, but the set top boxes report regularly, and the link can be checked and reestablished with every report from the set top box;
In some embodiments, the set top box is configured to report back to the television provider several times a day to cope with dynamic IP addresses (also cookies should persist);
For set top boxes not connected by an IP address, the same process can be used with the additional step of asking the panelist to visit a signup web page (which links the IP address at the household to the account associated with the set top box).
It is useful for panelists to regularly use the interactive application in order to refresh the correlation between IP address and panelist ID. Some embodiments encourage this behavior by making the interactive application a recommendation engine. The application sends the panelist IP address to the central server, which matches the panelist IP address to the set top box viewing history and the household web activity. Using this information, the interactive application recommends programs that the user may like.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for associating TV viewing with Internet activity, comprising:
at a server having one or more processors and memory storing programs for execution by the processors:
receiving from a TV service an IP address associated with an account of a TV subscriber, wherein the IP address is associated with a set top box employed by the TV subscriber to display TV content provided by the TV service, and wherein the IP address is associated with one or more computers of a household corresponding to the TV subscriber, the one or more computers configured to run web browsers;
receiving information on TV viewing of the TV subscriber, the information including the IP address;
receiving information on web browsing activity of the computers in the household associated with the IP address, the information including the IP address;
maintaining a TV log of the TV viewing of the TV subscriber;
maintaining an Internet log of the web browsing activity of the computers in the household associated with the IP address;
associating entries in the TV log with entries in the Internet log based, at least in part, on the IP address; and
storing the associations.

2. The method of claim 1, further comprising registering the TV subscriber as a server subscriber.

3. The method of claim 1, wherein the information on TV viewing is received from the set top box.

4. The method of claim 1, wherein the set top box is configured with a web browser, and at least a portion of the information on web browsing activity is received from the set top box.

5. The method of claim 1, further comprising providing recommended TV programs to the TV subscriber based on the associations.

6. The method of claim 1, further comprising providing a targeted television advertisement to the TV subscriber based on the associations.

7. The method of claim 1, further comprising providing a targeted Internet advertisement to the TV subscriber based on the associations, the Internet advertisement provided during web browsing.

8. A computer system for associating TV viewing with Internet activity, comprising:
memory;
one or more processors; and
one or more programs stored in the memory and configured for execution by the one or more processors, the one or more programs including:
instructions for receiving from a TV service an IP address associated with an account of a TV subscriber, wherein the IP address is associated with a set top box employed by the TV subscriber to display TV content provided by the TV service, and wherein the IP address is associated with one or more computers of a household corresponding to the TV subscriber, the one or more computers configured to run web browsers;
instructions for receiving information on TV viewing of the TV subscriber, the information including the IP address;
instructions for receiving information on web browsing activity of the computers in the household associated with the IP address, the information including the IP address;
instructions for maintaining a TV log of the TV viewing of the TV subscriber;
instructions for maintaining an Internet log of the web browsing activity of the computers in the household associated with the IP address;
instructions for associating entries in the TV log with entries in the Internet log based, at least in part, on the IP address; and
instructions for storing the associations.

9. The computer system of claim 8, further comprising instructions for registering the TV subscriber as a server subscriber.

10. The computer system of claim 8, wherein the information on TV viewing is received from the set top box.

11. The computer system of claim 8, wherein the set top box is configured with a web browser, and at least a portion of the information on web browsing activity is received from the set top box.

12. The computer system of claim 8, further comprising instructions for providing recommended TV programs to the TV subscriber based on the associations.

13. The computer system of claim 8, further comprising instructions for providing a targeted television advertisement to the TV subscriber based on the associations.

14. The computer system of claim 8, further comprising instructions for providing a targeted Internet advertisement to the TV subscriber based on the associations, the Internet advertisement provided during web browsing.

15. A non-transitory computer readable storage medium storing one or more programs to be executed by a computer system, the one or more programs comprising:
instructions for receiving from a TV service an IP address associated with an account of a TV subscriber, wherein the IP address is associated with a set top box employed by the TV subscriber to display TV content provided by the TV service, and wherein the IP address is associated with one or more computers of a household corresponding to the TV subscriber, the one or more computers configured to run web browsers;
instructions for receiving information on TV viewing of the TV subscriber, the information including the IP address;
instructions for receiving information on web browsing activity of the computers in the household associated with the IP address, the information including the IP address;
instructions for maintaining a TV log of the TV viewing of the TV subscriber;
instructions for maintaining an Internet log of the web browsing activity of the computers in the household associated with the IP address;
instructions for associating entries in the TV log with entries in the Internet log based, at least in part, on the IP address; and
instructions for storing the associations.

16. The non-transitory computer readable storage medium of claim 15, further comprising instructions for registering the TV subscriber as a server subscriber.

17. The on-transitory computer readable storage medium of claim 15, wherein the information on TV viewing is received from the set top box.

18. The on-transitory computer readable storage medium of claim 15, wherein the set top box is configured with a web browser, and at least a portion of the information on web browsing activity is received from the set top box.

19. The on-transitory computer readable storage medium of claim 15, further comprising instructions for providing recommended TV programs to the TV subscriber based on the associations.

20. The on-transitory computer readable storage medium of claim 15, further comprising instructions for providing a targeted television advertisement to the TV subscriber based on the associations.

21. The on-transitory computer readable storage medium of claim 15, further comprising instructions for providing a targeted Internet advertisement to the TV subscriber based on the associations, the Internet advertisement provided during web browsing.
